(19) United States
(12) Patent Application Publication
(10) Pub. No.: US 2011/0055025 A1
(43) Pub. Date: Mar. 3, 2011

(54) Component-Based Network-Delivered Advertising

(76) Inventor: Steve Krol, Orland Park, IL (US)

(21) Appl. No.: 12/859,992

(22) Filed: Aug. 20, 2010

Related U.S. Application Data
(60) Provisional application No. 61/237,139, filed on Aug. 26, 2009.

(51) Int. Cl. G06Q 30/00

(52) U.S. Cl. 705/14.73

(57) ABSTRACT

A single advertisement presented within a web page can be comprised of individual components: “ad beans”. Each ad bean can be directed to a single task and multiple ad beans can be combined within an advertising structure to provide a nearly limitless set of combinations and associated functionality. An advertising structure can act as a host for ad beans and can obtain the ad beans on a real-time basis from a remote source. The ad beans themselves can likewise obtain information on a real-time basis, such as from either the same, or a different, remote host. A single entity can thereby aggregate purchases of advertising such that the aggregator's purchase of advertising can be subsequently divided among differing entities such that each individual entity need only purchase a minimum amount of advertising from the aggregator that can be substantially lower than the minimum amount of advertising traditionally sold by publishers.

### CROSS-REFERENCE TO RELATED APPLICATION

This application claims priority from U.S. Provisional Pat. App. No. 61/273,139 filed Aug. 26, 2009, entitled “Content-Based Network-Delivered Advertising” the entire disclosure of which is hereby incorporated by reference.

### SUMMARY

In one embodiment, a single advertisement presented within a web page can be comprised of individual components, referred to hereinafter as “ad beans”. Each ad bean can be directed to a single task and multiple ad beans can be combined within an advertising structure to provide a nearly limitless set of combinations and associated functionality. An advertising structure can act as a host for ad beans and can obtain the ad beans on a real-time basis from a remote source. The ad beans themselves can likewise obtain information on a real-time basis, such as from either the same, or a different, remote host.

In another embodiment, by utilizing an ad structure that obtains ad beans on a real-time basis from a remote host, a single entity can aggregate purchases of advertising, such as are traditionally sold by one or more publishers of content on the network. The aggregator can provide the advertising structure that can be displayed together with the publisher's content in accordance with the advertising purchased by the aggregator. With each display of the advertising structure, the advertising structure can retrieve and instantiate a particular set of one or more ad beans, including, for example, the display of one or more ad beans that comprise advertisements for different entities. In such a manner, the aggregator's purchase of advertising can be subsequently divided among differing entities such that each individual entity need only purchase a minimum amount of advertising from the aggregator that can be substantially lower than the minimum amount of advertising traditionally sold by publishers, especially popular publishers whose content is often viewed.

In a further embodiment, an ad bean studio can be provided to enable entities to design their advertisements from a collection of one or more ad beans. The ad bean studio can enable entities to upload their content, including graphical content, audio content, data content, previous advertisements and other relevant content, to a remote host from which such content can be accessed on a real-time basis by ad beans, should such real-time access be desired. The ad bean studio can then enable individual entities to design individual ad beans, and advertisements comprising multiple ad beans. Additionally, to aid in the design of ad beans and advertisements, pre-generated layouts and ad beans can be offered, either free, or for a fee. Such pre-generated content can have been generated by external entities that can profit from its sale through the ad bean studio.

In a still further embodiment, because ad beans can support back-end communication, they can provide interactive aspects and continuous feedback information. The feedback information can be gathered, such as by a network host, and can be amalgamated to enable entities to view and understand the success of their advertising campaigns as measured by specified metrics. Additionally, predictive strategies can be utilized to predict future successes based on received feedback information. Weaknesses in an advertising campaign can be addressed automatically, either as part of an overall advertising campaign or individually at an ad bean level, since ad beans can have the capability to self-adapt based on prior successes or failures. Alternatively, the information provided to ad beans by a remote host can be adjusted in light of the successes or failures of other ad beans, as reported by those ad beans, thereby enabling ad beans to respond and adapt to empirical data without human intervention.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Additional features and advantages will be made apparent from the following detailed description that proceeds with reference to the accompanying drawings.

### DESCRIPTION OF THE DRAWINGS

The following detailed description may be best understood when taken in conjunction with the accompanying drawings, of which:

FIG. 1 is a block diagram of an exemplary advertising network;

FIG. 2 is a block diagram of an exemplary advertising display;

FIG. 3 is a component diagram of an exemplary advertising system;

FIG. 4 is a block diagram of an exemplary generation of an advertising campaign;

FIG. 5 is a block diagram of an exemplary advertising creation interface;

FIG. 6 is a block diagram of an exemplary advertising feedback interface;

FIG. 7 is a block diagram of an exemplary advertising element purchasing interface;

FIG. 8 is a component diagram of an exemplary advertising creation system;

FIG. 9 is a flow diagram of an exemplary presentation of advertisements; and

FIG. 10 is a block diagram of an exemplary computing device.

### DETAILED DESCRIPTION

The following description relates to the development, delivery and presentation of advertising within a network data browsing environment, such as the ubiquitous World Wide Web. A single advertisement presented within a web page can be comprised of individual components, referred to hereinafter as “ad beans”. Each ad bean can be directed to a single task and multiple ad beans can be combined within an advertising structure to provide a nearly limitless set of combinations and associated functionality. An advertising structure can act as a host for ad beans and can obtain the ad beans on a real-time basis from a remote source. The ad beans themselves can likewise obtain information on a real-time basis, such as from either the same, or a different, remote host.

By utilizing an ad structure that obtains ad beans on a real-time basis from a remote host, a single entity can aggregate purchases of advertising, such as are traditionally sold by one or more publishers of content on the network. The aggregator can provide the advertising structure that can be displayed together with the publisher's content in accordance with the advertising purchased by the aggregator. With each display of the advertising structure, the advertising structure can retrieve and instantiate a particular set of one or more ad beans, including, for example, the display of one or more ad beans that comprise advertisements for different entities. In such a manner, the aggregator's purchase of advertising can be subsequently divided among differing entities such that each individual entity need only purchase a minimum amount of advertising from the aggregator that can be substantially lower than the minimum amount of advertising traditionally sold by publishers, especially popular publishers whose content is often viewed.

An ad bean studio can be provided to enable entities to design their advertisements from a collection of one or more ad beans. The ad bean studio can enable entities to upload their content, including graphical content, audio content, data content, previous advertisements and other relevant content, to a remote host from which such content can be accessed on a real-time basis by ad beans, should such real-time access be desired. The ad bean studio can then enable individual entities to design individual ad beans, and advertisements comprising multiple ad beans. Additionally, to aid in the design of ad beans and advertisements, pre-generated layouts and ad beans can be offered, either free, or for a fee. Such pre-generated content can have been generated by external entities that can profit from its sale through the ad bean studio.

Because ad beans can support back-end communication, they can provide interactive aspects and continuous feedback information. The feedback information can be gathered, such as by a network host, and can be amalgamated to enable entities to view and understand the success of their advertising campaigns as measured by specified metrics. Additionally, predictive strategies can be utilized to predict future successes based on received feedback information. Weaknesses in an advertising campaign can be addressed automatically, either as part of an overall advertising campaign or individually at an ad bean level, since ad beans can have the capability to self-adapt based on prior successes or failures. Alternatively, the information provided to ad beans by a remote host can be adjusted in light of the successes or failures of other ad beans, as reported by those ad beans, thereby enabling ad beans to respond and adapt to empirical data without human intervention.

While the below descriptions are directed to advertising within the context of the World Wide Web, they are not so limited. Specifically, the general mechanisms and principles described below are equally applicable to any networked architecture, including networks of computing devices, television network and other audio or video networks so long as such networks are capable of, or can be designed to, support the communications and mechanisms described. As such, references to existing technologies and infrastructure, including the World Wide Web and technologies associated therewith, are meant to be exemplary only, and are not meant to limit the disclosure exclusively to those implementations.

Additionally, although not required, the descriptions below will be in the general context of computer-executable instructions, such as program modules, being executed by one or more computing devices. More specifically, the descriptions will reference acts and symbolic representations of operations that are performed by one or more computing devices or peripherals, unless indicated otherwise. As such, it will be understood that such acts and operations, which are at times referred to as being computer-executed, include the manipulation by a processing unit of electrical signals representing data in a structured form. This manipulation transforms the data or maintains it at locations in memory, which reconfigures or otherwise alters the operation of the computing device or peripherals in a manner well understood by those skilled in the art. The data structures, where data is maintained, are physical locations that have particular properties defined by the format of the data.

Generally, program modules include routines, programs, objects, components, data structures, and the like that perform particular tasks or implement particular abstract data types. Moreover, those skilled in the art will appreciate that the computing devices need not be limited to conventional personal computers, and include other computing configurations, including hand-held devices, multi-processor systems, microprocessor based or programmable consumer electronics, network PCs, minicomputers, mainframe computers, and the like. Similarly, the computing devices need not be limited to a stand-alone computing device, as the mechanisms may also be practiced in distributed computing environments where tasks are performed by remote processing devices that are linked through a communications network. In a distributed computing environment, program modules may be located in both local and remote memory storage devices.

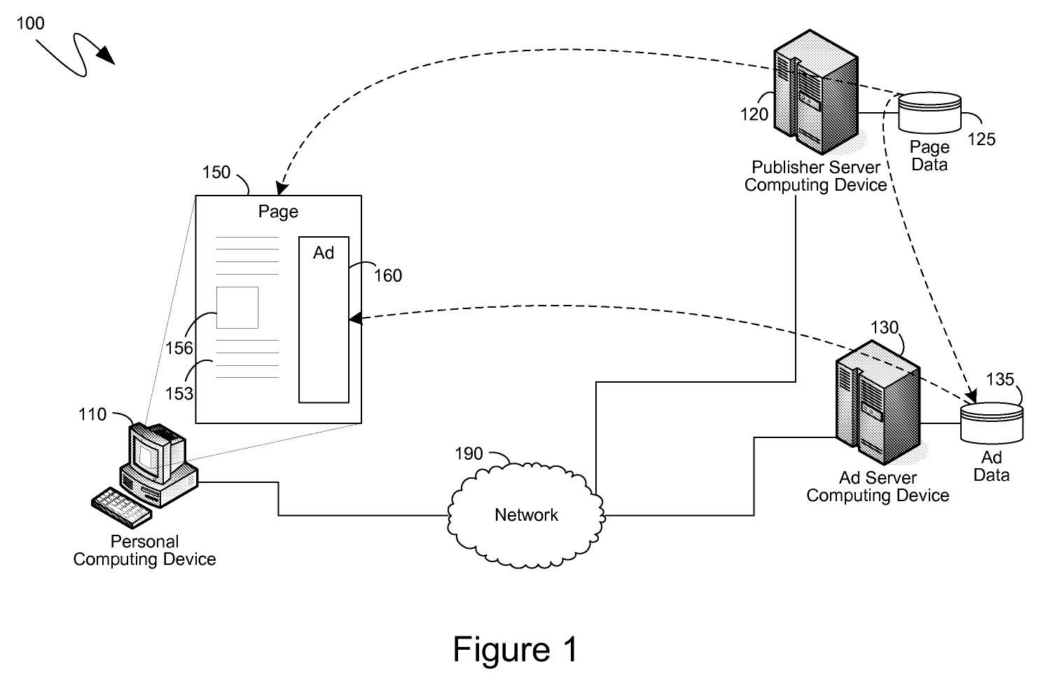

Turning to FIG. 1, a system 100 is shown, comprising three exemplary computing devices 110, 120 and 130 that are communicationally coupled to one another via the network 190. In the illustrated embodiment, the personal computing device 110 can display a page 150 comprising textual content 153 and visual, audio or audio/visual content 156. Traditionally, as will be known by those skilled in the art, the personal computing device 110 can execute an application program, such as ubiquitous web browser application program, to display the page 150 and associated content. The content and layout of the page 150 can be obtained by the personal computing device 110 and, more specifically, by the displaying application program, from a server computing device over the network 190. Thus, as shown in FIG. 1, the content and layout of the page 150 can be provided by a publisher server computing device 120, which can obtain the relevant page data 125 from a storage device communicationally coupled to the publisher server computing device.

The page 150, in addition to the above indicated content, can further comprise one or more advertisements, such as the ad 160. As will be known by those skilled in the art, traditionally the ad 160 is referenced by the page data 125 such that different ads 160 can be displayed in a predetermined section of the page 150 each time the page is viewed, such as by the personal computing device 110. More specifically, the page data 125 retained by, and provided by, the publisher server computing device 120, can include one or more references to ad data 135 as can be retained by, and provided by, an advertising server computing device 130. The personal computing device 110, then, when obtaining the page data 125 from the publisher server computing device 120 over the network 190, can also receive ad data 135 from the ad server computing device 130, again over the network 190.

Traditionally, to place an ad, such as the ad 160, on the page 150, an entity, such as a company desiring to advertise one or more products or services for sale, could purchase the right to place the ad 160 on the page 150 either directly from the publisher of the page or from one or more advertising networks which have a contractual agreement to place advertisements on pages published by a publisher. Such purchases are typically based on measurable metrics, such as the number of times that the ad 160 is displayed on a page, such as the page 150, published by the publisher, or the number of times that a user viewing the ad, such as a user of the personal computing device 110, actually interacts with the ad 160. Often, however, the minimum purchase amount can be fairly expensive and can provide for a greater quantity of views, or other such metric, than a smaller enterprise may wish to purchase.

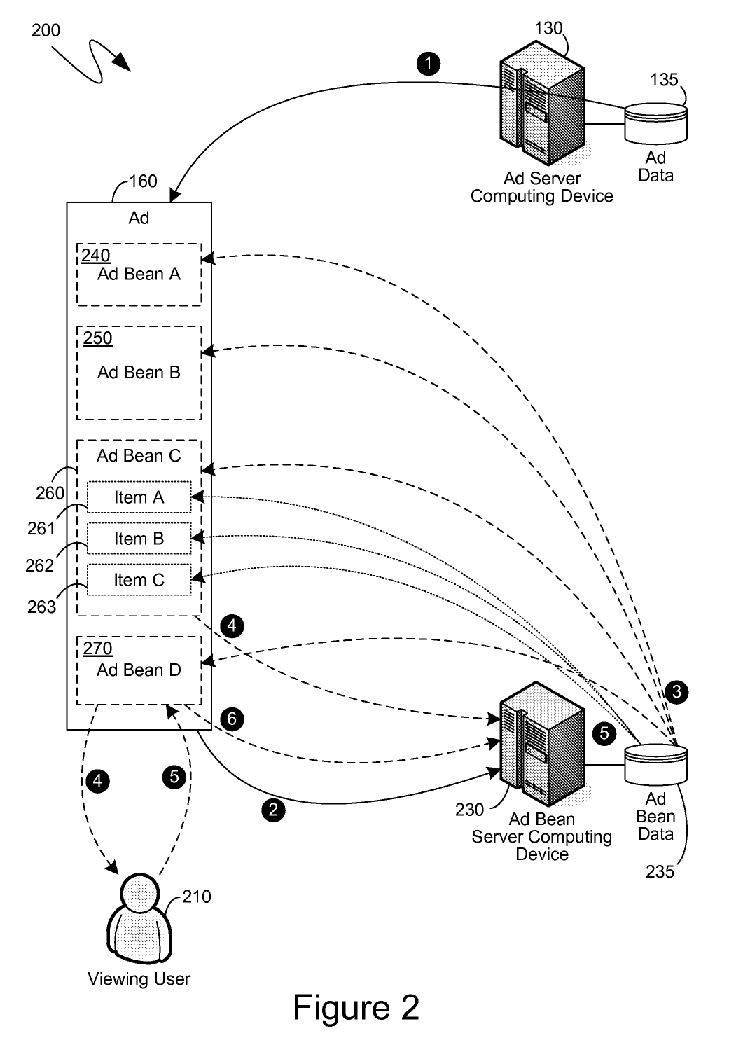

Turning to FIG. 2, an alternative structure contemplated by at least one embodiment is illustrated. As shown, the system 200 can comprise the ad 160 being displayed on the page 150 from FIG. 1 (though not specifically shown as such in FIG. 2 to avoid unnecessary visual complexity). As in FIG. 1, the ad 160 can be based on ad data 135 as provided by an advertising server computing device 130. Thus, as shown in FIG. 2, and as indicated graphically, in a first step the ad 160 can be instantiated from ad data 135 received from the ad server computing device 130. In the illustrated system 200, however, rather than comprising information regarding pre-defined elements, such as graphical images, animation files, or audio content, the ad data 135 can instead reference an empty container that can comprise sufficient capability to reference a host, and obtain therefrom, information regarding the content to be instantiated by the empty container.

More specifically, the ad data 135 can comprise instructions that are understandable by the application program that displays the page 150 (not shown) and that is executing on the personal computing device 110 (not shown). The application program can then provide for the execution of instructions on the personal computing device 110 in accordance with the instructions received as the ad data 135. The execution of such instructions can enable the ad 160 to act as a container and can further enable the ad to utilize the personal computing device 110 (not shown) to communicate with, and obtain additional data from, another computing device. For example, in the system 200 of FIG. 2, as indicated graphically, as a second step, the ad 160 can establish a communicational connection with another computing device, such as the ad bean server computing device 230. Although not specifically shown in FIG. 2, such a communicational connection, as will be understood by those skilled in the art, can be through a network, such as the network 190 of FIG. 1.

In addition to establishing a communicational connection with a computing device, such as the ad bean server computing device 230, the ad 160 can further, via the execution of the instructions provided as the ad data 135, identify itself and otherwise request, of the ad bean server computing device, the elements that are to be instantiated within the container provided by the ad 160. In one embodiment, the ad 160 can receive, in response, one or more “ad beans”. As indicated previously, an “ad bean” can be a collection of instructions that can perform a single or “quantum” task. An ad bean, therefore, can be analogous to a component in a componentized programming language or other componentized environment. Ad beans, like programming components, can be utilized in conjunction with one another to perform increasingly complex tasks.

Like the ad 160 itself, each ad bean can comprise instructions that can be understood or dealt with properly by the application program executing on the personal computing device 110 (not shown) that is displaying the page 150 (also not shown). Thus, in one embodiment, ad beans can comprise instructions conforming to the same programming construct as the ad 160 itself, while, in alternative embodiments, ad beans can comprise instructions conforming to different programming constructs. In yet another embodiment, ad beans can comprise instructions conforming to programming constructs that are foreign to, and not understood by, the application program executing on the personal computing device 110 (not shown) that is displaying the page 150 (also not shown). For example, one or more ad beans can comprise one or more downloadable components that the user can either execute within a different environment on the personal computing device 110 (not shown) or on another device altogether, such as a cellular telephone or a digital music player.

As shown in FIG. 2, after the second step, during which the ad 160 establishes communication with the ad bean server computing device 230, the ad bean server computing device can, as a third step, respond to the ad with one or ad beans, such as ad beans 240, 250, 260 and 270, that can be executed by the personal computing device 110 (not shown) and can provide an advertising presentation to a user of the personal computing device. For example, as part of the third step, the ad 160 can be provided with the ad bean 240 that can comprise instructions for, for example, the display of a logo or other identifier of an advertising entity. Similarly, again as part of the third step, the ad 160 can be provided with the ad bean 250 that can comprise instructions for, for example, the display of a current offer or other advertising-related information. In displaying the ad bean 240 and the ad bean 250, the personal computing device 110 (not shown) can execute relevant instructions that can be informed by the instructions provided to the ad 160 from the ad bean data 235. Such instructions can be executed within the context of the application displaying the page 150 (not shown) or an external application program.

Because ad beans, such as ad beans 240 and 250, can comprise instructions that can inform execution on the personal computing device, ad beans can, themselves, provide interactive or feedback functionality. For example, the ad bean 260, which can have been provided from the ad bean server computing device 230 in response to the original request from the ad 160, can itself contact a host, such as the ad bean server computing device, for additional, or updated, information. For example, the ad bean 260 can be configured to provide information, such as images of products being offered for sale or current pricing information, within the context of the ad 160. Such an ad bean 260 can, as part of a fourth step, as illustrated in FIG. 2, contact the ad bean server computing device 230, or another appropriate host. Such a contact can be independent of the contact established by the ad 160 as part of a second step. In response to such contact, and as part of a fifth step, as shown, the ad bean 260 can receive information to display, such as information regarding items 261, 262 and 263. For example, the ad bean 260 can receive pricing information, such that the display of the items 261, 262 and 263 comprises the most current pricing information, even pricing information that may have been added or modified after the ad 160 was already designed and distributed. Similarly, the ad bean 260 can receive product information, such that the display of the items 261, 262 and 263 comprises the most current items being offered or advertised, even items that may have been added or modified after the ad 160 was already designed and distributed.

In another embodiment, the ability of an ad bean, such as the illustrated ad bean 260, to obtain information in real-time from a host, such as the ad bean server computing device 230, can enable the ad bean and, ultimately, the ad 160 itself, to be self-adaptive. In particular, the information regarding, for example, items 261, 262 and 263 provided to the ad bean 260 to display in the ad 160 can be selected based on relevant feedback or metrics. In one embodiment, the ad bean server computing device 230 can select to provide information to the ad bean 260 regarding items 261, 262 and 263 that have been recently popular. Thus, as an example, if the ad 160 was for a movie rental store, the items 261, 262 and 263 can be particular movies and the ad bean server computing device 230 can provide information regarding those movies that have recently been popular. In another embodiment, the ad bean server computing device 230 can select to provide information regarding items 261, 262 and 263 that have been recently popular given specific parameters and as can be determined by feedback provided by other ad beans, such as will be described in further detail below. For example, as part of the request from the ad bean 260 for information from the ad bean server computing device 230, the ad bean 260 can provide identifying information including, for example, a network address of the personal computing device 110 (not shown) that is displaying the ad 160. From such a network address, as will be known by those skilled in the art, an approximate geographic location can be determined. The ad bean server computing device 230 can, thereby, identify items that have recently been popular within that geographic region. Thus, as an example, if the ad 160 was for a clothing reseller, the items 261, 262 and 263 displayed by the ad bean 260 can be cold weather clothing, such as sweaters, if the ad 160 were being displayed on a personal computing device 110 (not shown) whose network address indicated that it was located in a cold weather climate, while the same ad 160 and the same ad bean 260 can display warm weather clothing, such as shorts, as the items 261, 262 and 263 if the ad were being displayed on a personal computing device whose network address indicated that it was located in a warm weather climate.

In yet a further embodiment, an ad bean, such as the ad bean 260, can obtain information regarding the nature of the page 150 (not shown) within which the ad 160, hosting the ad bean 260, is being displayed. For example, the ad bean 260 can identify the page 150 (not shown) as part of a known collection of pages, such as those provided by a well known publisher. Alternatively, the ad bean 260 can even obtain some of the page's content, such as by searching for key words or performing other artificial intelligence utilizing the page's content as input. The resulting information can then be provided to, for example, the ad bean server computing device 230 when the ad bean 260 requests information regarding the items 261, 262 and 263 that it is to display. The ad bean server computing device 230 can, thereby, select items 261, 262 and 263 that are appropriate given the page 150 (not shown) on which the ad 160 is being displayed, and the ad bean server computing device can further provide information regarding such items to the ad bean 260. Thus, for example, if the ad bean 260 determines that it is part of an ad 160 being displayed on a page 150 (not shown) that comprises content directed towards a mostly male audience, the items 261, 262 and 263 can have been selected by the ad bean server computing device 230. Returning to the above movie rental example, in such a case, the items 261, 262 and 263 can be predominantly action movies. Similarly, if the ad bean 260 determines that it is part of an ad 160 being displayed on a page 150 (not shown) that comprises content directed towards a mostly female audience, then the items 261, 262 and 263 can be predominantly romantic comedies. However, as indicated previously, determinations, such as by the ad bean server computing device 230, need not be based on irrefutable assumptions. Thus, even if the ad bean 260 were indicating that it was displayed as part of an ad 160 that is displayed on a page 150 (not shown) whose content is male-oriented, if the ad bean server computing device 230 had received empirical data, such as from other ad beans, that the viewers of such pages, in fact, preferred, for example, romantic comedies, then the items 261, 262 and 263 about which information can be provided to the ad bean 260 can indeed be romantic comedies. In such a manner, the ad bean system can be self-adaptive and self-optimizing, without requiring manual intervention.

While ad beans, such as the above described exemplary ad beans 240, 250 and 260, can be directed to the display of information, other ad beans, such as the exemplary ad bean 270, can be directed towards the acquisition of information, such as from a viewing user 210 that is viewing the ad 160 and, thus, the ad bean 270. Thus, for example, the ad bean 270 can comprise instruction that can inform the execution of instructions by the personal computing device 110 (not shown) on which the ad 160 is being displayed and that can, thereby, cause the personal computing device to solicit, and accept, information from a viewing user 210. Such an ad bean 270 can comprise survey questions, forms or other types of input fields into which the viewing user 210 can enter information. Alternatively, the ad bean 270 can merely observe the viewing user's behavior, such as how long the personal computing device 110 (not shown) continues to display the page 150 (also not shown), or whether the viewing user 210 contemplates interacting with other ad beans, such as by hovering a pointer or other user interface element over them. The information gathered by an ad bean, such as the ad bean 270, can be communicated to an information collector, such as the ad bean server computing device 230 in the same manner that the ad bean 260 established a communicational connection with such a computing device. Thus, as shown in FIG. 2, as a fourth step, the ad bean 270 can solicit information from, or otherwise observe, a viewing user 210. As a fifth step, the ad bean 270 can receive information from the viewing user 210, either actively, or through passive observation. Then, as a sixth step, the ad bean 270 can provide the received information to the ad bean server computing device 230.

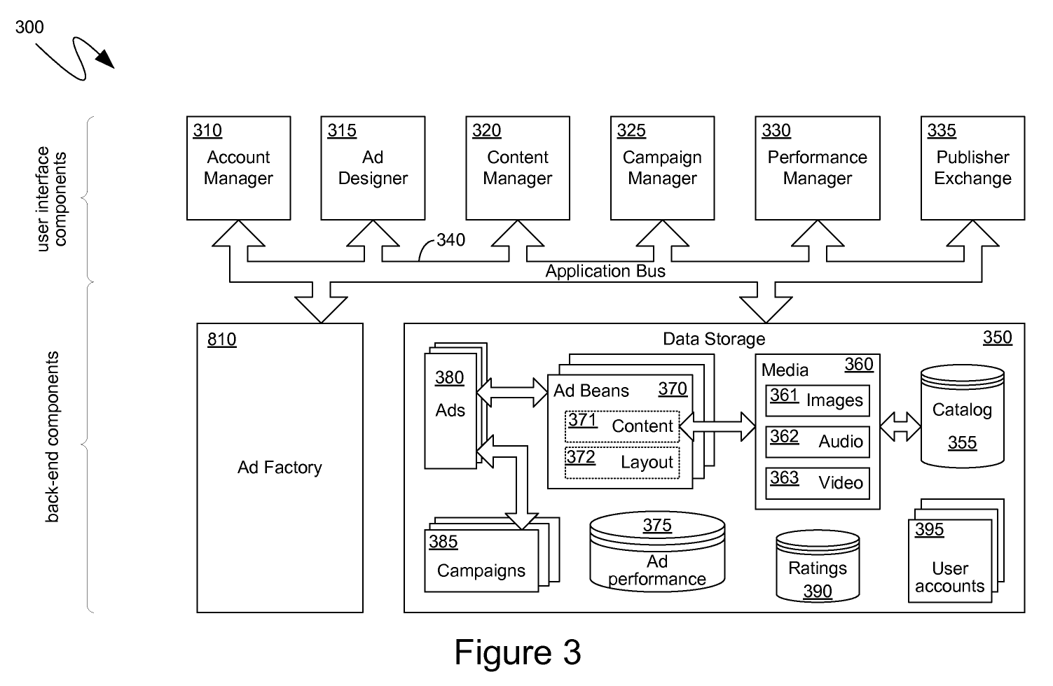

Turning to FIG. 3, the system 300 illustrates an exemplary advertising creation and modification mechanism that can be tailored to generate, and take advantage of, the unique features of ad beans, including the unique features described above and those which will be further described below. As can be seen from FIG. 3, the system 300 can comprise user interface components, such as the account manager 310, the ad designer 315, the content manager 320, the campaign manager 325, the performance manager 330 and the publisher exchange 335. The system 300 can further comprise back-end components such as the ad factory 810 and the data storage 350 that can act as a repository for ads 380, individual ad beans 370, various media 360, one or more catalogs of data 355, advertising campaigns 385, data regarding user accounts 395, and various feedback data such as ad performance 375 and ratings 390.

The user interface components of the system 300 can enable a user, such as an individual tasked with generating or updating one or more advertisements or advertising campaigns, to perform such generation or updating. Thus, the account manager 310 can enable a user to create an account, access an existing account, change account information and other like actions. The ad designer 315 can provide a user with an interface through which individual advertisements can be designed, such as through a combination of independent or symbiotic ad beans. In one embodiment the ad designer 315 can present an interface analogous to a drawing or page layout application program that can enable a user to visually arrange and assemble one or more advertisements.

Traditionally, those seeking advertising services already have an established collection of media that can be useful in generating and updating their advertisements. For example, they may possess digital images of products offered for sale, video or audio files of products or services to be advertised and other like information. They may additionally possess data regarding such products or services that can be linked to the audio, video or image media including, for example, price data, identification data, quantity available data and other like information. The content manager 320 can enable a user to transfer all of the relevant content that they may already posses from their storage to the data storage 350 of the system 300. Such content can include the media 360, which can comprise images 361, audio data 362 and video 363, and can include catalog data 355, which can provide additional data relevant to the media 360, such as pricing data, identification data, or other like relevant data.

The campaign manager 325 can enable a user of the system 300 to design and edit advertising campaigns that can comprise ads 380 and ad beans 370 that can have been designed through the ad designer 315. As will be described further below, the campaign manager 325 can provide visual feedback regarding various advertising campaign metrics, such as coverage, success rates, views and the geographic or temporal distribution thereof. In providing such information, the campaign manager 325 can operate in concert with the performance manager 330, which can collect and manage such information, including via access to the ad performance data 375. The campaign manager 325 can also operate in concert with the publisher exchange 335, which can enable a user of the system 300 to select or modify existing selections of publishers of content on whose pages, such as the page 150 (not shown) the user's advertisements will be displayed.

The data storage 350, as already indicated, can comprise media 360 and one or more catalogs 355 that can provide additional data about the media 360. Ad beans 370 can likewise be retained in the data storage 350 and can comprise ad bean content 371, ad bean layout information 372, and other like information or data. As shown in FIG. 3, the ad bean content 371 can reference, or be associated with, the media 360 and the information in the catalog 355. One or more ad beans 370, either in an independent or symbiotic manner, can be combined to form advertisements 380 which can then be coordinated into advertising campaigns 385, all of which can be retained in the data storage 350. The various user interface components, the ad factory 810, which will be described in greater detail below, and the data storage 350 can be communicationally coupled to one another through an application bus 340, which can comprise both internal and external communicational pathways.

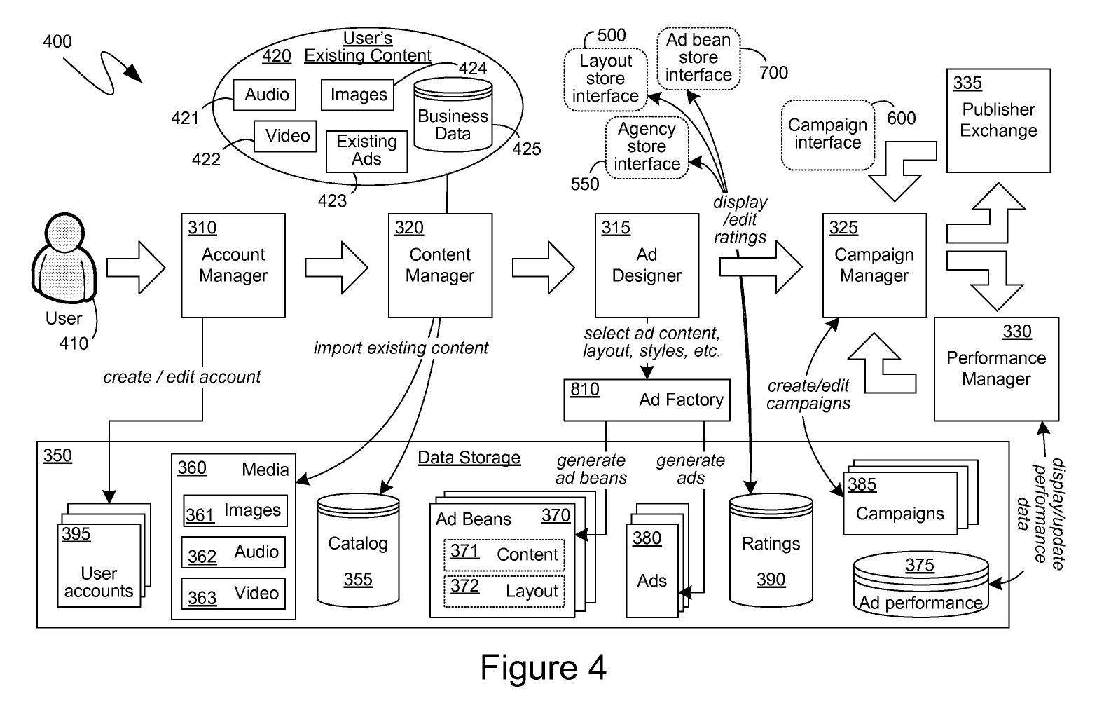

One exemplary process for utilizing some of the above described components to create or edit ad beans, advertisements or an advertising campaign is shown with reference to the system flow diagram 400 of FIG. 4. Turning to FIG. 4, as shown by the system flow diagram 400, a user 410 can initially utilize the account manage 310 to create or edit their account from among the user accounts 395 in the data storage 350. Subsequently, the user 410 can proceed to utilize the content manager 320 to import existing content 420 into the data storage 350. Thus, as shown, the user's existing content 420 can comprise audio content 421, video content 422, existing advertisements 423, such as those that do not utilize ad beans, images 424 and business data 425 that can comprise pricing information, identification information, and other information that can be associated with the other existing content 420. All such content can be imported, such as through the content manager 320, to the media 360 and the catalog 355 in the data storage 350.

Subsequently, the user 410 can proceed to utilize the ad designer 315 to edit or create advertisements 380 and ad beans 370. In one embodiment, the user 410 can utilize already created content to aid in their design. For example, as will be described further below, a layout store interface 500 can be presented to the user 410 as part of the ad designer 315, thereby enabling the user to select from among advertising layouts or other such advertising design elements that can have already been designed, either by the user or by other users. In one embodiment, other users can offer existing layouts for sale through the layout store interface 500. As another example of pre-created content that can be made available to a user, such as the user 410, through the ad designer 315, an ad bean store interface 700, which will be described further below, can enable the user 410 to select from among pre-programmed and pre-created ad beans, such as the ad beans 370 that can already be in the data storage 350. As with the layout store interface 500, the ad bean store interface 700 can enable other users to offer to sell ad beans that they can have already created. In such a manner, the user 410 can be offered a greater array and range of advertising design options than they may have been able to generate for themselves.

In yet another embodiment, an agency store interface 550 can be provided as part of the ad designer 315 through which the user 410 can select an advertising agency to design the user's advertisements for the user. The agency store interface 550, as will be described further below, can provide information about existing advertising agencies that are, for example, familiar with or capable of interacting with, the system 300. The agency store interface 550, the layout store interface 500 and the ad bean store interface 700 can further enable users, such as the user 410, to provide, and view, feedback on the various items offered through such interfaces. The ratings 390 of various ad beans 370 offered through the ad bean store interface 700, of various layouts offered through the layout store interface 500, or of various ad agencies offering their services through the agency store interface 550 can be retained as part of the data storage 350 and can be utilized by the user 410 in selecting from among the offerings.

Once the user has designed various advertisements 380 or portions of advertisements, such as the ad beans 370, the specifications of such designs, including, for example, layouts, content, styles, images and other like information, can be provided by the ad designer 315 to the ad factory 810. As shown in FIG. 4, and as will be described in further detail below, the ad factory 810 can, based on the specifications provided by the ad designer 315, generate the designed ad beans 370 and the advertisements 380.

The user 410 can then proceed to the campaign manager 325 which can provide an interface 600 and, in conjunction with the publisher exchange 335 and the performance manager 330, enable the user to coordinate their advertising campaign utilizing, for example, the advertisements 380 and the ad beans 370 in the data storage 350. In one embodiment, as will be described further below with reference to the campaign interface 600 the campaign manager 325 can provide, to the user 410, a visual interface for displaying relevant metrics regarding the advertising campaign selected by the user 410.

In another embodiment, in addition to the display of such metrics, the campaign manager 325 can provide, to the user 410, the option of selecting a self-adjusting campaign. As indicated previously, ad beans, such as those utilized in the advertising campaign, can provide feedback information, which can be received by, or otherwise processed by, the performance manager 330, and can be stored as part of the ad performance data 375 in the data storage 350. From such information, the performance manager 330, and the campaign manager 325, can automatically identify specific advertising trends, successes and failures, and can automatically adjust the advertising accordingly. For example, if the ad performance 375 indicates that ad beans displaying one type of offer are no longer successful, utilizing any of several known metrics for measuring advertising success, the campaign manager 325 and inform the ad bean server computing device 230 (not shown) to provide, in response to future ad bean requests, information to the requesting ad beans that will cause the display of another, different, type of offer. Similarly, if the ad performance 375 indicates that a particular market demographic has not yet seen an advertising campaign, the campaign manager 325 can select publishers, such as via the publisher exchange 335, that publish content specifically directed to such a demographic.

The user 410, however, can retain the ability to manually adjust, or manually override, any of the above described exemplary parameters. For example, the user 410 can utilize the publisher exchange 335 to specifically select or exclude certain identified publishers to control the content and context within which the user's advertisements are displayed. Similarly, the user 410 can access, or even edit, if the user is granted such privileges, the ad performance data 375 through the performance manager 330.

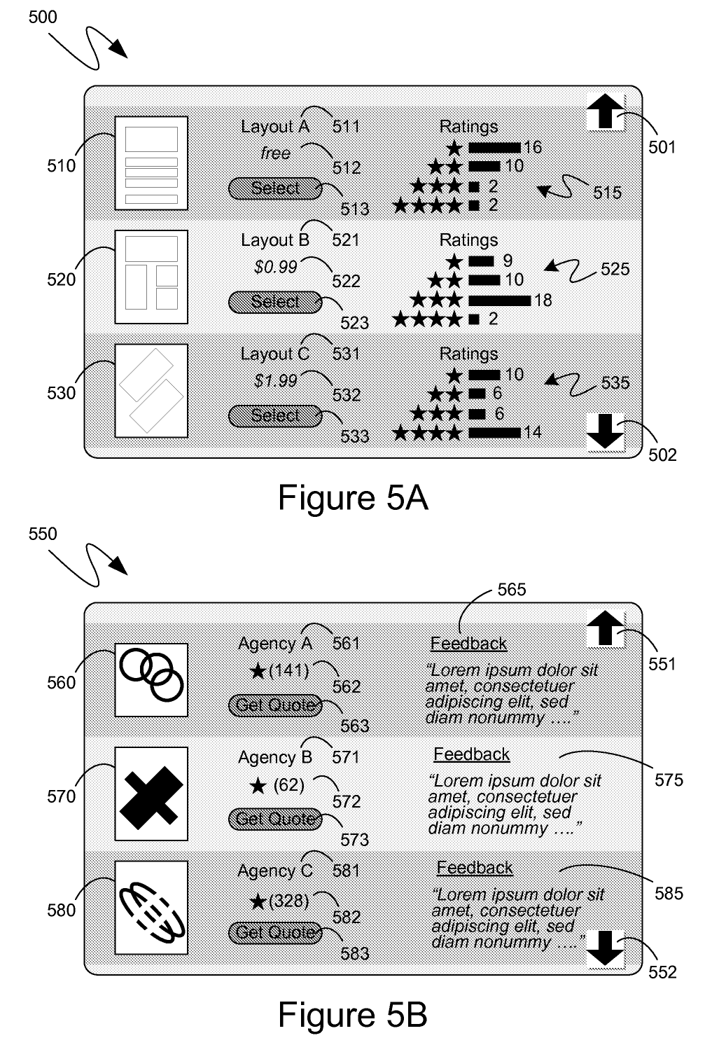

Turning to FIGS. 5A and 5B, the aforementioned layout store interface 500 and the agency store interface 550 are further described with reference to exemplary embodiments thereof illustrated in FIGS. 5A and 5B. As will be recognized by those skilled in the art, the illustrated exemplary interfaces 500 and 550 are exemplary only and are only meant to provide a basis for description of specific elements of such interfaces. In no way are the illustrated exemplary interfaces of FIGS. 5A and 5B meant to limit the below descriptions to the specific visual orientations and representations provided.

As can be seen from the exemplary layout store interface 500 shown in FIG. 5A, a number of layouts, such as exemplary layouts 510, 520 and 530 can be presented to the user 410 (not shown), such as in an list, as shown, or in another multi-element organizational structure through which the user can browse or search, such as via the browsing elements 501 and 502. Together with each layout, identifying information, or other information the user 410 (not shown) may deem relevant, can be presented to the user. For example, the name of the layout, the cost, if any, for a user to use the layout, and feedback information about the layout from other users can be presented. Thus, in the exemplary layout store interface 500, the layout 510 can have displayed with it its name 511, its cost 512, its ratings 515 and a selection mechanism 513 with which a user can select such a layout for their own advertisement. The exemplary layouts 520 and 530 can likewise have their names 521 and 531, their cost 522 and 532, their ratings 525 and 535, and their selection mechanisms 523 and 533, respectively, displayed together with the layouts.

In one embodiment, such as that illustrated in FIG. 5A, the layout store interface 500 can include ratings information, such as ratings 515, 525 and 535, which are illustrated in a conventional format in which layouts are assigned stars by other users, with a greater number of stars signifying a greater satisfaction by that user with the layout, and the total number of users assigning a particular level of stars to the layout being displayed. However, as will be recognized by those skilled in the art, other systems of ratings or displaying ratings can likewise be utilized. For example, an average number of stars given to a layout by prior users can be displayed, or the layout can be graded, such as on a numerical or alphabetic scale. Additionally, although not shown in the exemplary layout store interface 500, such an interface can further comprise feedback information in which users can leave detailed comments that may be of assistance to other users considering such layouts in the future. As indicated previously, such information can be stored as ratings data 390 (not shown) in the data storage 350 (also not shown).

FIG. 5B illustrates an exemplary agency store interface 550, though, as will be recognized by those skilled in the art, elements of the exemplary agency store interface 550 can be relevant to the exemplary layout store interface 500, and vice versa. The exemplary agency store interface 550 can comprise a listing, or other presented set, of various advertising agencies that can be hired, such as by the user 410 (not shown), to design ad beans, advertisements, or advertising campaigns for the user. As with the exemplary layout store interface 500, the exemplary agency store interface 550 can comprise browsing elements 551 and 552 and, although not specifically illustrated in FIG. 5B, can further comprise a search interface or other like browsing or searching functionality.

The information displayed about an advertising agency can comprise, for example, a logo of the agency, a name of the agency, a selection mechanism by which the user can contact the agency, and feedback about the agency from other users who have used the agency. For example, in the exemplary agency store interface 550, an agency logo 560 can be displayed with the agency's name 561, feedback information, such as in the form of aggregate feedback 562 and individual feedback 565, and a selection mechanism 563. Agency logos 570 and 580 can, likewise, be displayed with the agencies' names 571 and 581, aggregate feedback information 572 and 582, individual feedback information 575 and 585, and selection mechanisms 573 and 583, respectively.

As before, the feedback mechanisms shown are merely exemplary and those of skill in the art will recognize that other mechanisms for providing user feedback are equally applicable. Thus, while the exemplary agency store interface 550 shows aggregate ratings 562, 572 and 582 which, as will be known, traditionally reflect an aggregate number of positive responses from prior users of the agency, other forms of displaying or summarizing user feedback, including those described above, are equally applicable.

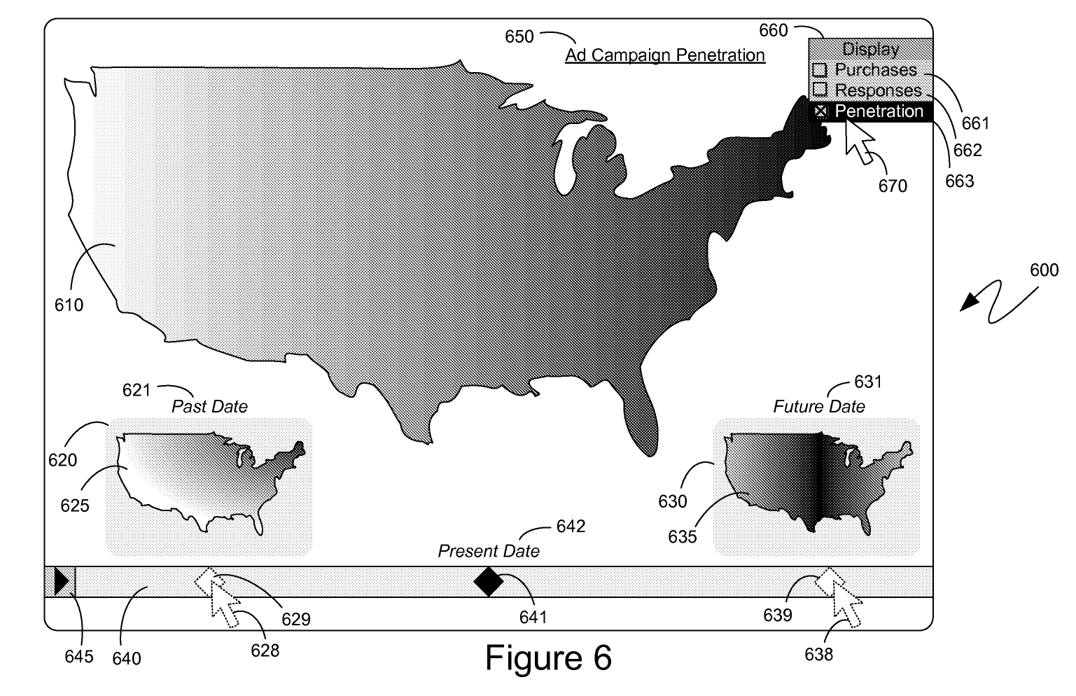

Turning to FIG. 6, an exemplary campaign interface 600 is shown. As with the above described exemplary interfaces, the exemplary campaign interface 600 is meant to only illustrates examples of various aspects of a campaign interface and is not meant to limit the below descriptions to the specific graphical representations illustrated. As will be recognized by those skilled in the art, multiple interface mechanisms can be utilized to perform the equivalent functionality described below.

In one embodiment, the exemplary campaign interface 600 can comprise graphical representations of various advertising performance metrics. For example, as shown in FIG. 6, the exemplary campaign interface 600 can comprise a graphical representation of various advertising performance metrics within the context of the geological location at which such advertising was viewed or presented. Thus, the exemplary campaign interface 600 comprises a map 610 that can illustrate, such as through shading, coloring or other like graphical representation various advertising performance metrics. A title 650 can indicate which one or more performance metrics are currently being displayed and a menu 660, or other user selection interface element, can enable a user, such as the user 410 (not shown), to select from among different performance metrics to be displayed, such as a quantity of purchases 661 generated by the displayed advertisements, a quantity of user responses 662 to the advertisements, or a penetration 663 of the advertisements. In the exemplary campaign interface 600, the penetration 663 metric is shown as being selected by the cursor 670.

In another embodiment, the exemplary campaign interface 600 can provide advertising performance metrics in a temporal manner. For example, like an animated weather map, the map element 610 can display an animation, including an interactive animation, that can visualize the changes in the displayed metrics over time. Thus, as shown in FIG. 6, the exemplary campaign interface 600 can comprise a progress bar 640 and progress indicator 641, or other analogous temporal indicators, that can indicate a particular instant in time. The exemplary campaign interface 600 can further comprise a “play” button 645 or similar interface element that can activate, or pause, the display of changing advertising metrics over time across the map 610.

Together with the progress indicator 641, the exemplary campaign interface 600 can further indicate, such as via the text 642, a particular date to which the currently displayed map 610 corresponds. In one implementation, dragging the progress indicator 641 along the progress bar 640, such as with the cursor 670 can result in the display of a smaller map that previews advertising metric data at the time corresponding to the location of the dragged progress indicator 641 along the progress bar 640. Thus, if the progress indicator 641 were dragged to the location 629 by the cursor at location 628 as shown, then a preview 620 illustrating an advertising metric on the map 625 as of a prior date 621, can be displayed.

In a further embodiment, future advertising metrics can be prognosticated, such as by the performance manager 330 (not shown), based on the ad performance data 375 (also not shown) that has been received to date. To illustrate such an embodiment, the exemplary campaign interface 600 illustrates the dragging of the progress indicator 641 to a location 639, with a cursor location 638, corresponding to a future date, as indicated by the date text 631 displayed above the preview 630. As can be seen from the exemplary campaign interface 600, the preview 630 can comprise a map 635 that can illustrate one or more advertising performance metrics that can be based on extrapolated performance data. As will be known to those skilled in the art, numerous mathematical models exist for the extrapolation of data given an existing set of prior data, and any such models can be equally used for the extrapolations contemplated to provide the relevant data for the display of future predicted advertising metrics.

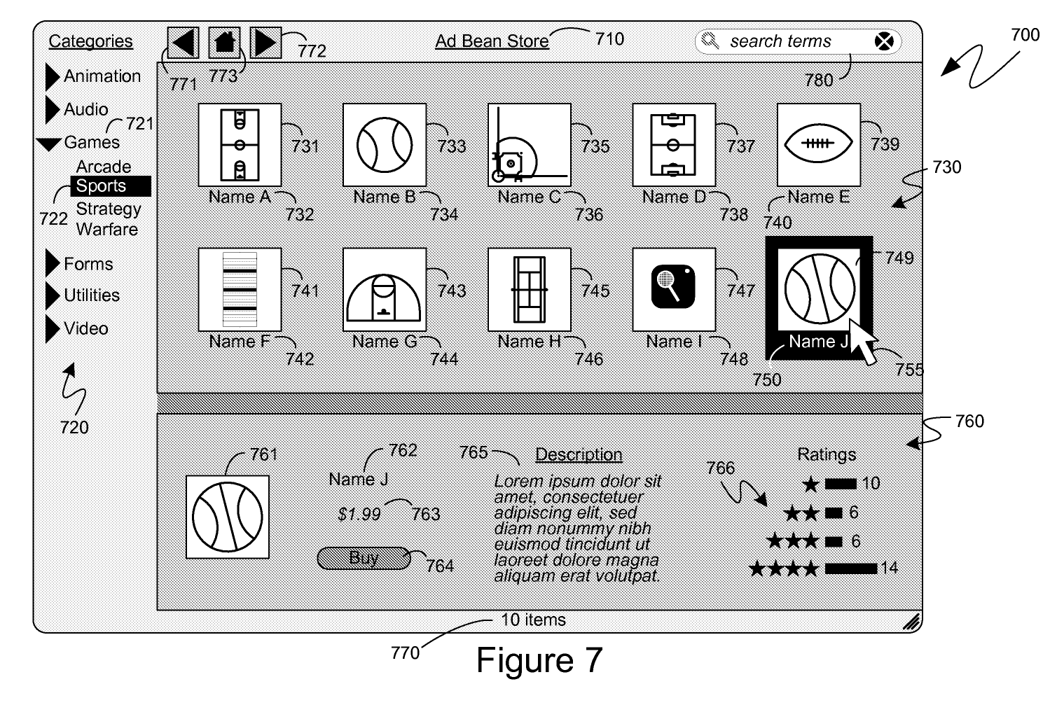

As described above, ad beans can act as components that can provide a predetermined and defined set of functionality. Consequently, much like the components of modern application programs, it is contemplated that a nearly limitless number of ad beans can be created to perform a nearly limitless number of different functions. As a result, an ad bean store can be provided through which users can exchange, or even sell, ad beans they have created for use by other users in those other users' advertisements. Turning to FIG. 7 an exemplary ad bean store interface 700 is illustrated. Again, as before, the illustrated interface is merely exemplary and, as will be known by those skilled in the art, any number of interface designs can be utilized to provide for the below described aspects. As such, the exemplary ad bean store interface 700 is not meant to limit the descriptions below to the specific graphical orientation illustrated in FIG. 7.

In one embodiment, the exemplary ad bean store interface 700 can comprise a title 710, an indication of the number 770 of ad beans currently being displayed, a search interface 780 through which a user can search for ad beans via keywords or other search strategies, and a series of categories 720 which a user can utilize to search for, or browse through, specific types of ad beans. The exemplary ad bean store interface 700 can further comprise browsing elements, such as a forward arrow 772, a back arrow 771 and a home button 773 that can return a browsing or searching user to a common, initial location.

The exemplary ad bean store interface 700 can further comprise a display 730 of individual ad beans and a display 760 of details regarding a selected ad bean. As will be recognized by those skilled in the art, the display 730 and the display 760 can be part of separate interfaces, such as one being displayed after selection of element in another, but, for ease of illustration within a single figure, they are shown within the same exemplary ad bean store interface 700. The ad beans displayed within the display 730 can, in one embodiment, be displayed as a series of icons, or other visually identifying elements, such as screen shots. In another embodiment, the ad beans displayed within the display 730 can be displayed as a series of identifying textual information, such as ad bean names. In yet another embodiment, both visual and textual identifying aspects, such as icons and names, can be displayed within the display 730. In the exemplary ad bean store interface 700, ad bean icons 731, 733, 735, 737, 739, 741, 743, 745, 747 and 749 are shown, in conjunction with associated names 732, 734, 736, 738, 740, 742, 744, 746, 748 and 750, respectively.

The ad bean corresponding to the icon 749 and the name 750 is further illustrated as having been selected, such as by the cursor 755. As such, the icon 749 is further displayed as icon 761 in the display 760 and the name 750 is further displayed therein as name 762. The display 760 can also comprise other information about the selected ad bean, such as a price 763, a selection element 762, a detailed description 765 and ratings 766. As described above, the ratings 766 are illustrated in an exemplary summary star format and other mechanisms, including aggregating mechanisms and individual, detailed feedback mechanisms can likewise be utilized or displayed. Similarly, the description 765 can comprise screen shots or other images of the ad bean, or any other information that a user may find valuable in determining whether to utilize or purchase the ad bean for use in their advertisements.

In the illustrated embodiment, the games 721 category of ad beans can have been selected, and a sub-category of sports 722 can likewise have been selected, as shown in the exemplary ad bean store interface 700. The display 730, therefore, can display those ad beans conforming to such a selected sub-category. Such ad beans can, for example, comprise ad beans that can provide viewing users, such as the viewing user 210 (not shown), the opportunity to play games within the context of an advertisement, such as in an effort to entice the user to interact with the advertisement.

To provide for the creation of ad beans, such as those that can be sold through the above-described ad bean store, an integrated development environment for ad beans can be provided. In one embodiment, the integrated development environment can comprise an editor for programming one or more ad beans in a supported programming language, a compiler or interpreter for compiling or interpreting the source code and a debugging tool for simplifying and aiding in the debugging of ad beans. The integrated development environment can further comprise build automation support for creating ad beans and packaging them for distribution.

In a further embodiment, the integrated development environment can further comprise visual programming support, such as the ability to enable programmers to create ad beans through manipulation of graphical elements that represent components of underlying source code. Alternatively, or in addition, a graphical user interface layout environment can be provided by which a programmer can position user interface elements in a graphical manner.

To provide for greater interoperability, ad beans can conform to a standardized Application Program Interface (API). For example, the ad container 160 and the ad bean server computing device 230, both of FIG. 2, can communicate with ad beans through a standardized API, thereby enabling any ad bean conforming to such an API to be usable by the container and further enabling any ad bean conforming to such an API to communicate with, obtain information from, and provide information to, the ad bean server computing device.

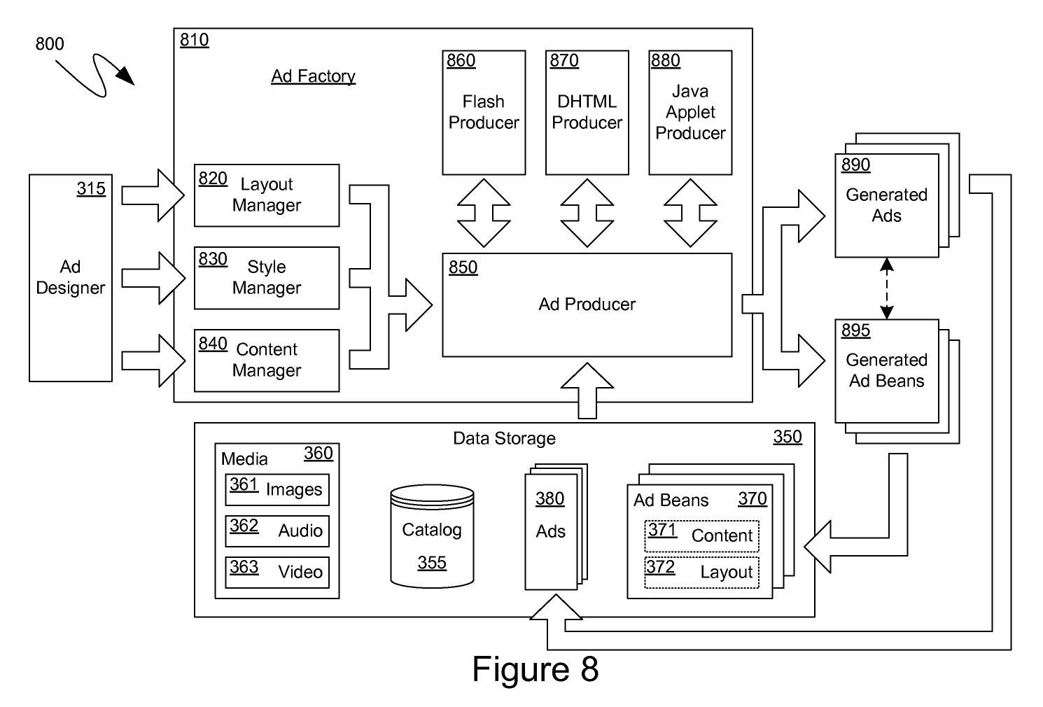

Turning to FIG. 8, the ad factory 810, referenced above in connection with FIGS. 3 and 4, is illustrated in greater detail. Once a user, such as the user 410 (not shown), has designed an advertisement, an ad bean, or a combination thereof, the ad designer 315 can transmit the specifications of the designed elements to the ad factory 810 as shown in the system 800 of FIG. 8. The transmitted specifications can comprise layout information, style information, content information and any other information that can be utilized, or can be helpful, in generating the designed advertisement, ad bean, or combinations thereof. The ad factory 810 can, in one embodiment, comprise a layout manager 820, a style manager 830, a content manager 840 and other mangers not specifically shown in FIG. 8. Each of the managers can be directed towards relevant portions of the specification provided by the ad designer 315 and can instruct the ad producer 850 to generate appropriate advertisements or ad beans based on their interpretation of the relevant portions of the provided specification.

The ad producer 850 can, in one embodiment, comprise communicational connections to content-specific producers, such as the Flash producer 860, the DHTML producer 870 and the Java applet producer 880 shown in FIG. 8. The Flash producer 860 can comprise instructions relevant to the creation of ad beans and advertisements that can conform to the Flash multimedia platform currently distributed by Adobe Systems. Similarly, the DHTML producer 870 can comprise instructions relevant to the creation of ad beans and advertisements that can conform to the Dynamic HyperText Markup Language collection of technologies, such as JavaScript and the Document Object Model, and the Java applet producer 880 can comprise instructions relevant to the creation of ad beans and advertisements that can conform to the Java programming language developed by Sun Microsystems. Other content-specific producers, such as producers directed to the production of advertisements and ad beans on mobile computing platforms, such as cellular telephones, can likewise be utilized by the ad producer 850.

The ad producer 850 can accept the information provided by the layout manager 820, the style manager 830, the content manager 840 and any other relevant manager and can generate ad beans 895 and advertisements 890 with reference to appropriate ones of the Flash producer 860, DHTML producer 870, Java applet producer 880 or other relevant content-specific producers. For example, specifications from the ad designer 315 can indicate that a particular layout is to be implemented for an advertisement, that the text and graphics utilized in the advertisements are to conform to specific styles, and that the advertisement is to include an ad bean that will display a list of products being offered for sale. In such a case, the layout manager 820 can parse the specification provided by the ad designer 315 and can identify specific layout aspects that can be translated into an intermediate format that the ad producer 850 can utilize in conjunction with, for example, the Flash producer 860 to generate an advertisement conforming to the Flash multimedia platform, or, alternatively, in conjunction with the Java applet producer 880 to generate an advertisements conforming to the Java programming language, which, in either case, can comprise the specified layout. The style manager 830 can, likewise, parse the specification provided by the ad designer 315 and generate an intermediate specification of the styles to be utilized that can be accepted by the ad producer 850 and, in conjunction with relevant ones of the content-specific producers 860, 870 and 880, can generate advertisements with the specified styles. The content manager 850 can also parse the specification provided by the ad designer 315 and can provide, to the ad producer 850, the relevant descriptions that the ad producer can then utilize, in conjunction with the content-specific producers 860, 870 and 880, to generate advertisements and ad beans in accordance with the specified output format.

In addition, the ad producer 850 can accept the ad bean API, described above, and can provide for the compliance, with such an API, of the advertisements 890 and the ad beans 895 generated by the ad producer. More specifically, the communications contemplated and specified by the ad designer can be implemented by the ad producer 850 in accordance with the standardized ad bean API. Similarly, the generated advertisements 890 and generated ad beans 895 can be designed by the ad producer 850 to accept communications and data in conformance with the API.

Because the ad producer 850 can accept multiple content-specific producers such as the content-specific producers 860, 870 and 880, the advertisements and ad beans 895 generated by the ad producer can be any of a myriad of output formats, including, for example, portable application formats and formats applicable to mobile computing platforms, such as cellular telephones, digital music players and the like. The generated advertisements 890 can reference the generated ad beans 895, or other ad beans 370 stored in the data storage 350. Once generated, the advertisements 890 and the ad beans 895 can be stored back in the data storage 350, as shown in the system 800 of FIG. 8.

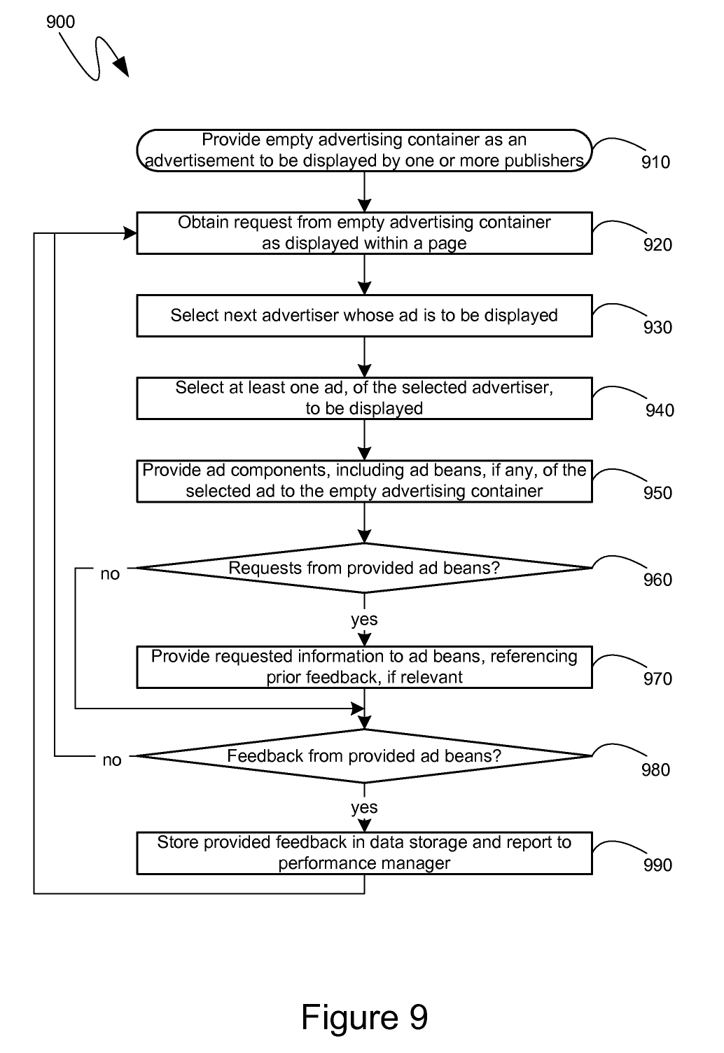

Turning to FIG. 9, the advertising aggregation abilities of the above described mechanisms are described further with reference to the flow diagram 900 of FIG. 9. As shown in the flow diagram 900, initially, at step 910, an empty advertising container, such as that described previously, can be provided to one or more publishers or advertising agencies to be displayed as an advertisement on a page, such as the page 150 (not shown). As indicated previously, such a providing of advertising content can be in conjunction with a purchase of a minimum amount of advertising, which can still be quite large, especially for smaller advertising consumers.

Subsequently, at step 920, the empty advertising container can be placed on a page 150 (not shown) that is displayed on a personal computing device 110 (also not shown) and, as a result of such a placement and display, the advertising container can contact a host and the host can receive that advertising container's request. At step 930 a determination can be made of an advertiser whose ad is to be displayed. More specifically, multiple advertisers can purchase advertising from an advertising aggregator, and the minimum amount of advertising purchased can be substantially less that traditional minimums, especially for high profile publishers or advertising networks. The advertising aggregator can the, at step 930, select the next such advertiser whose ad is to be displayed in the empty container. In such a manner, a single empty advertising container provided at step 910 to publishers or advertising agencies, from whom a large amount of advertising can be required to be purchased, can show, in successive displays on different computing devices, different advertisements from different advertisers. The different advertisers can, thereby, divide the large amount of advertising purchased and can display their advertisements on pages which they could traditionally not have afforded.

Returning to step 930, the advertising aggregator can select, at step 930, the next advertiser whose ad is to be displayed in the empty container. Such a selection can be based on a number of factors, including, for example, the amount of money each advertiser paid, the prior number of instances in which each advertisers ad was displayed, and other like factors. Once an advertiser is selected at step 930, the specific ad of that advertiser that is to be displayed can be selected at step 940. As indicated previously, such a selection of ads can be based on feedback provided by previously displayed advertisements and ad beans and, in such a manner, the displayed advertisements can be self-modifying and self-optimizing.

Once an advertisement is selected at step 940, the components of the selected advertisement, including any ad beans, if present in the selected advertisement, can be provided to the empty advertising container at step 950. A monitoring process can monitor for additional requests from the provided ad beans. If such a monitoring process detects such requests at step 960, then, at step 970, the requested information can be provided. Again, as indicated previously, the provided information can be based on feedback provided by previously displayed ad beans, and other feedback sources, to enable the advertisement, and, specifically, the ad beans within the advertisement, to be self-modifying and self-optimizing. If a monitoring process, however, does not detect such a request at step 960, then processing can skip to step 980.

At step 980, another monitoring process can monitor for feedback or other information or metrics that can be received from the provided ad beans. If such information or metrics are received, as determined by the monitoring process at step 980, then, at step 990, the received data can be stored in the data storage and the performance manger, described in detail above, can be notified. Relevant processing can then return to step 920 to wait for another empty container to be placed on, and displayed on, a page, such as the page 150 (not shown). Alternatively, if, at step 980, the monitoring process does not detect any feedback from an ad bean, the relevant processing can skip to step 920.

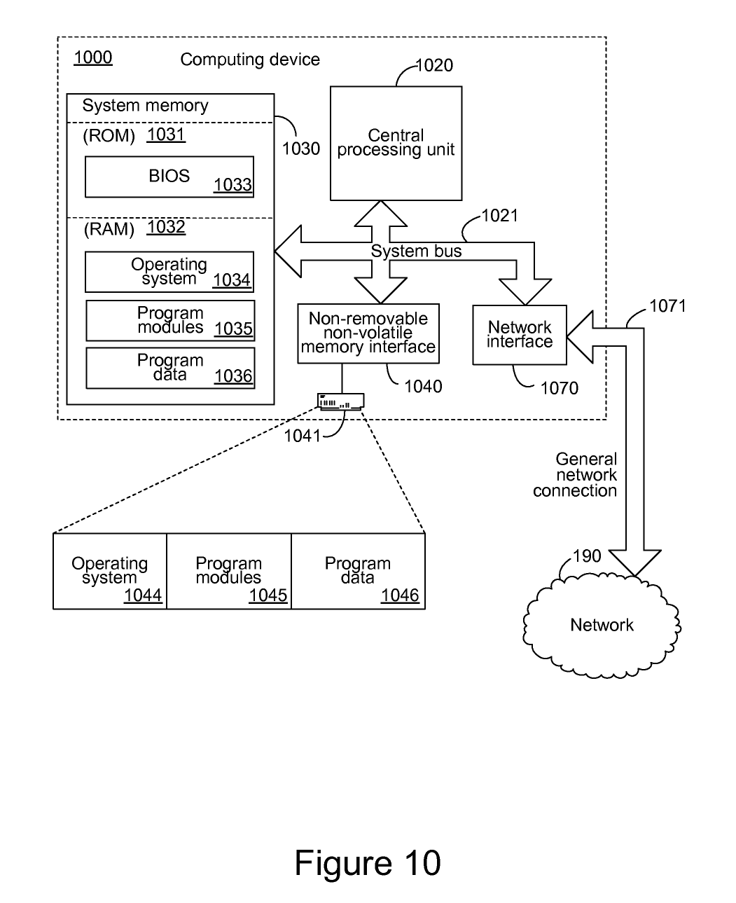

Turning to FIG. 10, an exemplary computing device 1000 is illustrated to provide context for the above descriptions as they relate to the execution of instructions by a computing device in order to perform at least some of the above described actions. The exemplary computing device 1000 of FIG. 10 can include, but is not limited to, one or more central processing units (CPUs) 1020, a system memory 1030, and a system bus 1021 that couples various system components including the system memory to the processing unit 1020. The system bus 1021 may be any of several types of bus structures including a memory bus or memory controller, a peripheral bus, and a local bus using any of a variety of bus architectures.

The computing device 1000 also typically includes computer readable media, which can include any available media that can be accessed by computing device 1000 and includes both volatile and nonvolatile media and removable and non-removable media. By way of example, and not limitation, computer readable media may comprise computer storage media and communication media. Computer storage media includes media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 1000. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 1030 includes computer storage media in the form of volatile and/or nonvolatile memory such as read only memory (ROM) 1031 and random access memory (RAM) 1032. A basic input/output system 1033 (BIOS), containing the basic routines that help to transfer information between elements within computing device 100, such as during start-up, is typically stored in ROM 1031. RAM 1032 typically contains data and/or program modules that are immediately accessible to and/or presently being operated on by processing unit 1020. By way of example, and not limitation, FIG. 10 illustrates operating system 1034, other program modules 1035, and program data 1036.

The computing device 1000 may also include other removable/non-removable, volatile/nonvolatile computer storage media. By way of example only, FIG. 10 illustrates a hard disk drive 1041 that reads from or writes to non-removable, nonvolatile magnetic media. Other removable/non-removable, volatile/nonvolatile computer storage media that can be used with the exemplary computing device include, but are not limited to, magnetic tape cassettes, flash memory cards, digital versatile disks, digital video tape, solid state RAM, solid state ROM, and the like. The hard disk drive 1041 is typically connected to the system bus 1021 through a non-removable memory interface such as interface 1040.

The drives and their associated computer storage media discussed above and illustrated in FIG. 10, provide storage of computer readable instructions, data structures, program modules and other data for the computing device 100. In FIG. 10, for example, hard disk drive 1041 is illustrated as storing operating system 1044, other program modules 1045, and program data 1046. Note that these components can either be the same as or different from operating system 1034, other program modules 1035 and program data 1036. Operating system 1044, other program modules 1045 and program data 1046 are given different numbers hereto illustrate that, at a minimum, they are different copies.

Additionally, the computing device 1000 may operate in a networked environment using logical connections to one or more remote computers. For simplicity of illustration, the computing device 1000 is shown in FIG. 10 to be connected to a network 190, such as that illustrated in FIG. 1, above, that is not limited to any particular network or networking protocols. The logical connection depicted in FIG. 10 is a general network connection 1071 that can be a local area network (LAN), a wide area network (WAN) or other network. The computing device 1000 is connected to the general network connection 1071 through a network interface or adapter 1070 which is, in turn, connected to the system bus 1021. In a networked environment, program modules depicted relative to the computing device 1000, or portions or peripherals thereof, may be stored in the memory of one or more other computing devices that are communicatively coupled to the computing device 1000 through the general network connection 1071. It will be appreciated that the network connections shown are exemplary and other means of establishing a communications link between computing devices may be used.

We claim:

1. One or more computer-readable media comprising computer-executable instructions for displaying multiple independent advertisements within a single advertising space on a web page, the computer-executable instructions performing steps comprising:
providing an advertising container as an advertisement to be displayed in the single advertising space on the web page;
receiving a request from the advertising container as displayed in the single advertising space on the web page;
selecting a subsequent advertisement, comprising advertisement components, to be displayed;
providing the subsequent advertisement to the advertising container for display within the single advertising space on the web page;
receiving at least one request from at least one advertisement component of the subsequent advertisement that was provided to the advertising container;
transmitting, to the at least one advertisement component, a response to the at least one request; and
receiving feedback from at least one advertisement component of the subsequent advertisement that was provided to the advertising container.
